(19) United States
(12) Patent Application Publication
(10) Pub. No.: US 2009/0229460 A1
(43) Pub. Date: Sep. 17, 2009

(54) SYSTEM FOR GENERATING AN OXYGEN-ENRICHED GAS

(76) Inventors: Michael S. McClain, Ortonville, MI (US); Dana G. Pelletier, Ortonville, MI (US); Michael P. Chekal, Brighton, MI (US)

Correspondence Address: DELPHI TECHNOLOGIES, INC., M/C 480-410-202, PO BOX 5052, TROY, MI, 48007, US

(21) Appl. No.: 12/047,867

(22) Filed: Mar. 13, 2008

(51) Int. Cl. B03C 3/00; B01D 53/047

(52) U.S. Cl. 95/96; 96/108

(57) ABSTRACT

A system for generating oxygen includes a compression means configured to compress a feed gas including at least nitrogen and oxygen, and at least one sieve bed configured to generate an oxygen-enriched gas from the compressed feed gas. The sieve bed(s), having an internal gas pressure ranging from about 1 psi to about 10 psi, include a housing and a nitrogen-adsorption material operatively disposed in the housing. The nitrogen-adsorption material is configured to adsorb at least nitrogen from the compressed feed gas during a pressure swing adsorption process, thereby generating an oxygen-enriched gas for a user.

### BACKGROUND

The present disclosure relates generally to oxygen generation, and, more particularly, to oxygen generating systems.

Oxygen generating systems are often used to produce an oxygen-enriched gas for a user. Oxygen generating systems typically include a gas fractionalization system configured to separate oxygen from other components (e.g., nitrogen) in a feed gas to produce the oxygen-enriched gas. The gas fractionalization system, for example, may include one or more sieve beds having a nitrogen-adsorption material disposed therein and configured to adsorb at least nitrogen from the feed gas.

Many oxygen generating systems employ Standard Pressure Swing Adsorption (PSA) technology to separate the oxygen from the other components present in the feed gas. During PSA, nitrogen is selectively adsorbed in the nitrogen-adsorbing material due to pressure changes in the sieve beds, leaving the oxygen-enriched gas to be delivered to the user. The sieve beds in these oxygen generating systems are typically operated at a sieve bed pressure above 10 psi and, in some instances, up to about 40 psi. At these relatively high pressures, the gases flowing through the sieve beds (i.e., at least the feed gas and the oxygen-enriched gas) flow at a relatively low flow rate such as, e.g., from about 1 to about 10 slpm.

### SUMMARY

A system for generating oxygen includes a compression means configured to compress a feed gas including at least nitrogen and oxygen, and at least one sieve bed configured to generate an oxygen-enriched gas from the compressed feed gas. The sieve bed(s), having an internal gas pressure ranging from about 1 psi to about 10 psi, include a housing and a nitrogen-adsorption material operatively disposed in the housing. The nitrogen-adsorption material is configured to adsorb at least nitrogen from the compressed feed gas during a pressure swing adsorption process, thereby generating an oxygen-enriched gas for a user.

### BRIEF DESCRIPTION OF THE DRAWINGS

Features and advantages of the present disclosure will become apparent by reference to the following detailed description and the drawings, in which like reference numerals correspond to similar, though perhaps not identical components. For the sake of brevity, reference numerals or features having a previously described function may or may not be described in connection with other drawings in which they appear.

FIG. 1 is a schematic diagram of an example of an oxygen generating system; and

FIG. 2 is a semi-schematic, perspective, cut-away view of a sieve bed used in the oxygen generating system of FIG. 1.

### DETAILED DESCRIPTION

Embodiment(s) of the method as disclosed herein advantageously use an oxygen generating system that employs a PSA process in at least one sieve bed to separate oxygen from other components in a feed gas, where the sieve bed(s) have an internal pressure that is substantially low, i.e., ranging from about 1 to about 10 psi. This substantially low internal sieve bed pressure is achieved by selecting an appropriate compression means for compressing the feed gas flowing into the sieve bed(s). In some examples, the substantially low internal sieve bed pressure may be further facilitated by substantially evenly distributing the flow of the feed gas and/or the oxygen-enriched gas through the sieve bed(s). By operating the sieve bed(s) at the substantially low internal pressure, the oxygen generating system may be structurally constructed to be substantially smaller in size (in terms of volume), as well as lighter in weight. For example, the thickness of the sieve bed housing may be substantially thinner or scaled down, as well as many, if not all, of the conduits and valves employed in the system. Also, such smaller sieve beds, conduits, and/or valves tend to consume less power. All of these factors may be particularly advantageous in portable applications, i.e., applications in which the oxygen generating system is made small enough and light enough for a user to carry around with him/her. Further, the sieve bed(s) having the lower internal pressure allow the oxygen generating system to operate substantially quietly and for longer durations of time with respect to battery power. Yet further, the oxygen generating system(s) according to examples of the present disclosure may tend to have a longer operative life and may require less outside servicing.

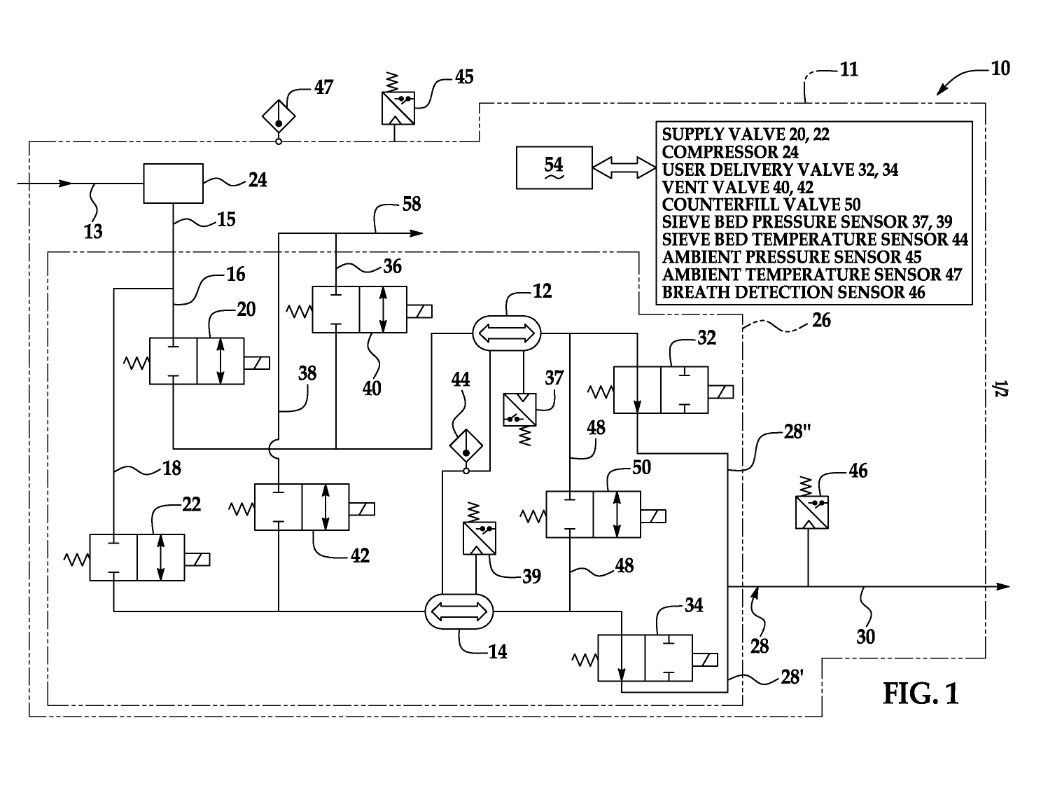

One non-limiting example of an oxygen generating system suitable for use with embodiment(s) of the method disclosed herein is depicted in FIG. 1. However, it is to be understood that any oxygen generating system may be suitable for use with the embodiment(s) disclosed herein, various examples of which (not shown) are oxygen generating system(s) having fill valves (any suitable combination of 2-way, 3-way, 4-way valves, etc.), vent valves (any suitable combination of 2-way, 3-way, 4-way valves, etc.), a product tank(s), bleed orifice(s) and patient valving.

It is to be understood that the nitrogen-adsorption process employed by the oxygen generating system may be a pressure swing adsorption (PSA) or a vacuum pressure swing adsorption (VPSA) process, and such processes operate in repeating adsorption/desorption cycles.

The oxygen generating system 10 includes a housing 11 having an inlet 13 configured to receive a feed gas. In a non-limiting example, the feed gas is air taken from the ambient atmosphere, which includes at least nitrogen and oxygen.

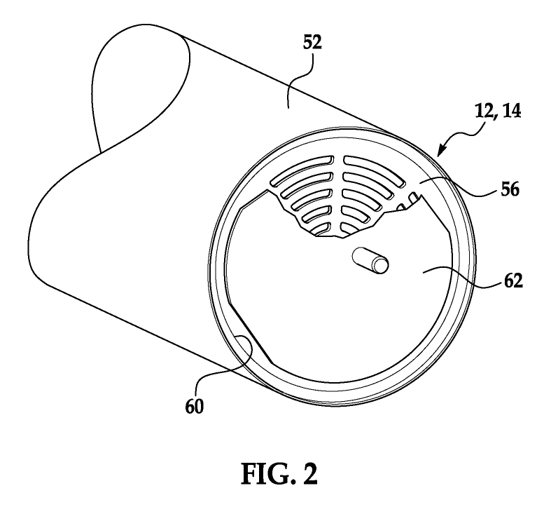

The oxygen generating system includes at least one sieve bed. In the example shown in FIG. 1, the oxygen generating system 10 includes first 12 and second 14 sieve beds, each in selective fluid communication with the feed gas. As shown in FIG. 2, the sieve beds 12, 14 include a housing 52 having a nitrogen-adsorption material (not shown) operatively disposed therein.

Referring again to FIG. 1, in an embodiment, each of the first 12 and second 14 sieve beds is configured to selectively receive the feed gas during a predetermined supply period. The first 12 and second 14 sieve beds may receive the feed gas via first 16 and second 18 supply conduits, respectively. The first 16 and second 18 supply conduits receive the feed gas from a feed gas supply line 15.

The first 16 and second 18 supply conduits are generally operatively connected to respective first 20 and second 22 supply valves (or inlet valves). In a non-limiting example, the first 20 and second 22 supply valves are two-way valves. As provided above, the nitrogen-adsorption process employed by the oxygen generating device 10 operates via cycles, where one of the first 12 or second 14 sieve beds vents purge gas (i.e. nitrogen-enriched gas), while the other of the first 12 or second 14 sieve beds delivers oxygen-enriched gas to the user. During the next cycle, the functions of the respective sieve beds 12, 14 switch. Switching is accomplished by opening the respective feed gas supply valve 20, 22 while the other of the feed gas supply valves 20, 22 is closed. More specifically, when one of the first 12 or second 14 sieve beds is receiving the feed gas, the respective one of the first 20 or second 22 supply valves is in an open position. In this case, the feed gas is prevented from flowing to the other of the first 12 or second 14 sieve beds. In an embodiment, the opening and/or closing of the first 20 and second 22 supply valves may be controlled with respect to timing of opening and/or closing and/or with respect to the sequence in with the first 20 and second 22 supply valves are opened and/or closed.

In an embodiment, the feed gas is compressed prior to entering the feed gas supply line 15 via a compression means 24. Further detail of the compression means 24 is provided below.

After receiving the compressed feed gas, the first 12 and second 14 sieve beds are each configured to separate at least most of the oxygen from the feed gas to produce the oxygen-enriched gas. In an embodiment, the first 12 and second 14 sieve beds are each sieve beds 12, 14 including the nitrogen-adsorption material (e.g., zeolite, other similar suitable materials, and/or the like) configured to adsorb at least nitrogen from the feed gas. As schematically shown in phantom in FIG. 1, the sieve beds 12, 14 are operatively disposed in a housing 11 that includes sieve module 26.

In a non-limiting example, the oxygen-enriched gas generated via the PSA process includes a gas product having an oxygen content ranging from about 70 vol % to about 95 vol % of the total gas product. In another non-limiting example, the oxygen-enriched gas has an oxygen content of at least 87 vol % of the total gas product.

A user conduit 28 having a user outlet 30 is in alternate selective fluid communication with the first and second sieve beds 12, 14. The user conduit 28 may be formed from any suitable material, e.g., at least partially from flexible plastic tubing. In an embodiment, the user conduit 28 is configured substantially in a “Y” shape. As such, the user conduit 28 may have a first conduit portion 28′ and a second conduit portion 28″, which are in communication with the first sieve bed 12 and the second sieve bed 14, respectively, and merge together before reaching the user outlet 30. The user outlet 30 may be an opening in the user conduit 28 configured to output the substantially oxygen-enriched gas for user use. The user outlet 30 may additionally be configured with a nasal cannula, a respiratory mask, or any other suitable device, as desired.

In an embodiment, as shown in FIG. 1, the oxygen delivery device 10 also includes a sieve bed pressure sensor 37, 39 for the sieve beds 12, 14, respectively, and a sieve bed temperature sensor 44 configured to measure the pressure and temperature, respectively, of the first 12 and second 14 sieve beds during the PSA process. In another embodiment, a single pressure sensor may be used to measure the pressure of each of the sieve beds 12, 14, whereby the delivery device 10 may include additional equipment used for selecting the desired sieve bed 12, 14 that the pressure sensor is intended to measure. The device 10 further includes an ambient pressure sensor 45 and an ambient temperature sensor 47 to measure the pressure and temperature, respectively, of the ambient environment.

The first conduit portion 28′ and the second conduit portion 28″ may be configured with a first user delivery valve 32 and a second user delivery valve 34, respectively. In an embodiment, the first 32 and the second 34 user delivery valves are configured as two-way valves. It is contemplated that when the oxygen-enriched gas is delivered from one of the first and second sieve beds 12, 14, to the user conduit 28, the respective one of the first 32 or second 34 user valves is open. Further, when the respective one of the first 32 or second 34 user valves is open, the respective one of the first 20 or second 22 feed gas supply valves is closed.

The nitrogen-adsorption process selectively adsorbs at least nitrogen from the feed gas. Generally, the compressed feed gas is introduced into one of the first 12 or the second 14 sieve beds, thereby pressurizing the respective first 12 or second 14 sieve bed. Nitrogen and possibly other components present in the feed gas are adsorbed by the nitrogen-adsorption material disposed in the respective first 12 or second 14 sieve bed during an appropriate PSA cycle. After: a predetermined amount of time; reaching a predetermined target pressure; detection of an inhalation; and/or another suitable trigger, the pressure of the respective first 12 or second 14 sieve bed is released. At this point, the nitrogen-enriched gas (including any other adsorbed components) is also released from the respective first 12 or second 14 sieve bed and is vented out of the system 10 through a main vent conduit 58. As shown in FIG. 1, the nitrogen-enriched gas in the first sieve bed 12 is vented through a vent port/conduit 36 for the first sieve bed 12 when a first vent valve 40 is open, and the nitrogen-enriched gas in the second sieve bed 14 is vented through a vent conduit 38 for the second sieve bed 14 when a second vent valve 42 is open. The vent conduits 36 and 38 merge into the main vent conduit 58. It is to be understood that venting occurs after each dynamically adjusted oxygen delivery phase and after counterfilling, each of which will be described further below. The gas not adsorbed by the nitrogen-adsorption material (i.e., the oxygen-enriched gas) is delivered to the user through the user outlet 30.

In an embodiment, delivery of the oxygen-enriched gas occurs during or within a predetermined amount of time (i.e., a masked time) after the dynamically adjusted oxygen delivery phase from the respective first 12 or second 14 sieve bed. For example, the oxygen delivery system 10 may be configured to trigger an output of a predetermined volume of the oxygen-enriched gas from the sieve bed 12 upon detection of an inhalation by the user. Detection of an inhalation may be accomplished via, e.g., a breath detection device, schematically shown as reference numeral 46 in FIG. 1. The predetermined volume, which is at least a portion of the oxygen-enriched gas produced, is output through the user conduit 28 and to the user outlet 30 during a respective dynamically adjusted oxygen delivery phase.

The first 12 and second 14 sieve beds are also configured to transmit at least a portion of the remaining oxygen-enriched gas (i.e., the oxygen-enriched gas not delivered to the user during or after the masked time to the user outlet 30), if any, to the other of the first 12 or second 14 sieve bed. This also occurs after each respective dynamically adjusted oxygen delivery phase. The portion of the remaining oxygen-enriched gas may be transmitted via a counterfill flow conduit 48. The transmission of the remaining portion of the oxygen-enriched gas from one of the first 12 or second 14 sieve beds to the other first 12 or second 14 sieve beds may be referred to as “counterfilling.”

As shown in FIG. 1, the counterfill flow conduit 48 may be configured with a counterfill flow valve 50. In a non-limiting example, the counterfill flow valve 50 is a two-way valve. The counterfill flow valve 50 is opened to allow the counterfilling of the respective first 12 and second 14 sieve beds.

The compression means 24, the first 20 and second 22 supply valves, the first 32 and second 34 user delivery valves, and the first 40 and second 42 vent valves are controlled by a controller 54. The sieve bed pressure sensors 37, 39, and the sieve bed temperature sensor 44 measure internal system parameters, and the ambient pressure sensor 45 and the ambient temperature pressure sensor 47 measure ambient atmospheric parameters, all of which are inputs to the controller 54. In a non-limiting example, the controller 54 is a microprocessor including a memory. The controller 54 generally receives, e.g., sieve bed pressures, and other similar variables, and uses these variables to execute one or more algorithms for controlling various components and/or processes used in the system 10.

The system 10 may further include other internal components such as, e.g., a manifold (not shown) that is operatively connected to the sieve beds 12, 14, and a filter (also not shown) that is operatively disposed in the system 10 between the compression means 24 and the sieve beds 12, 14. Details for the manifold may be found in U.S. application Ser. No. 12/070,647, filed Feb. 20, 2008, which is commonly owned by the Assignee of the present disclosure, and is incorporated herein by reference in its entirety. Details for the filter may be found in U.S. application Ser. No. 12/070,917, filed Feb. 21, 2008, which is commonly owned by the Assignee of the present disclosure, and is also incorporated herein by reference in its entirety.

As provided above, a substantially low internal pressure of the sieve beds 12, 14 is accomplished by selecting an appropriate compression means 24 for the system 10. As used herein, a “substantially low internal sieve bed pressure” refers to an internal pressure of the sieve beds 12, 14 ranging from about 1 psi to about 10 psi. In some examples, the sieve beds 12, 14 may have a substantially low internal pressure ranging from about 2 psi to about 9 psi; from about 3 psi to about 8 psi; from about 4 psi to about 7 psi; from about 3 psi to about 6 psi. In yet another example, the sieve beds 12, 14, may have a substantially low internal pressure of about 5 psi. It is to be understood that the PSA process is generally a function of the volume of the sieve beds 12, 14. With smaller internal sieve bed pressures, the amount of material used for the housing 52 of the sieve beds 12, 14, and/or the thickness of the housing 52 would also be smaller. It is further to be understood that the flow rate of the gases flowing through the sieve beds 12, 14 would increase in order to achieve a desired oxygen output. As such, to operate the sieve beds 12, 14 at a lower pressure such as, e.g., at 1 psi, the oxygen generating system 10 would be constructed as desired to accommodate the lower pressure and, yet, the higher flow rate.

In a non-limiting example, the compression means 24 is a compressor designed to be used in the system 10 to achieve a substantially low internal sieve bed pressure. An example of a suitable compressor includes, but is not limited to, a scroll compressor such as the one disclosed in U.S. Pat. No. 6,758,659, assigned to Scroll Laboratories, Inc., which is incorporated herein by reference in its entirety. Other non-limiting examples of suitable compressors include scroll compressors manufactured by Air Squared, Inc., Broomfield, Colo.; high volume piston compressors such as those manufactured by Thomas, Sheboygan, Wis.; and rotary vane compressors such as those also manufactured by Thomas. In instances where the internal sieve bed pressure ranges from about 1 psi to about 2 psi, any one of the compressors provided above may suitably be used as the compression means 24. Additionally, when the sieve beds 12, 14 include a substantially low internal pressure ranging from about 1 psi to about 2 psi, the system 10 may alternatively use an air blower as the compression means 24.

It is to be understood that the substantially low internal sieve bed pressure may be achieved by controlling the speed of the compression means 24. For example, if a compressor is used for the compression means 24, controlling the speed of the compressor may be accomplished by controlling a pulse width modulation (PWM) setting of the compressor 24 via the controller 54. It is to be understood that pressure drops of the feed gas may occur in the system 10 as the feed gas flows from the compression means 24 to the sieve beds 12, 14. These pressure drops are believed to be caused from at least changes in the size of the supply conduits 16, 18, the supply valves 20, 22, the manifold, the filter, and/or other components that may be present in the system 10 between the compression means 24 and the sieve beds 12, 14. It is also believed that pressure drops may occur as a result of packaging the components of the system 10 in a smaller volumetric space so that the system 10 may be more advantageously designed for portable applications. As such, the feed gas may be pressurized to a value that is higher than the desired substantially low internal sieve bed pressure. In a non-limiting example, the feed gas may be pressurized via the compression means 24 to a value ranging from about 1 psi to about 2 psi higher than the desired substantially low internal sieve bed pressure to accommodate anticipated pressure drops in the system 10.

It is to be understood that the compression means 24 is also selected based on a substantially high flow rate of gases (e.g., at least the feed gas and the oxygen-enriched gas) flowing through the sieve beds 12, 14 during the PSA cycle. As referred to herein, a “substantially high flow rate” of the gases flowing through the sieve beds 12, 14 is a flow rate (of any one of the feed gas, the oxygen-enriched gas, and/or other gases that may be present in the sieve beds 12, 14). It is to be understood that the substantially high flow rate is dependent on the substantially low internal sieve bed pressure (i.e., the substantially low internal pressure of the sieve bed 12, 14, will generally dictate the appropriate flow rate of the gases flowing through the sieve beds 12, 14 in order to achieve the desired oxygen output). The substantially high flow rate is also dependent on the size of the compression means 24, as well as the amount of power needed to operate the compression means 24. Also, a desired range of the substantially high flow rate is one that will maximize the flow of the gases in all conditions during each PSA cycle. In a non-limiting example, the substantially high flow rate is greater than about 10 slpm. In another non-limiting example, the substantially high flow rate ranges from about 10 slpm to about 30 slpm.

In an embodiment, the sieve beds 12, 14 having a substantially low internal pressure and a substantially high flow rate of gases flowing therethrough may in some instances be facilitated by substantially evenly distributing the flow of at least one of the feed gas or the oxygen-enriched gas through the sieve beds 12, 14. Without being bound to any theory, it is believed that evenly distributing the flow of the gases through the sieve beds 12, 14 reduces the overall resistance to flow of the gases inside of the sieve beds 12, 14. It is also believed that evenly distributing the flow of gases through the sieve beds 12, 14 increases the efficiency of the sieve beds 12, 14, where all portions of the sieve beds 12, 14 are exposed to substantially the same amount of nitrogen to be adsorbed by the nitrogen-adsorption material during the PSA process. In the event that the gases are not evenly distributed through the sieve beds 12, 14, the oxygen generating system 10 may be operated relatively slowly so that the sieve beds 12, 14, and possibly other components of the system 10, are not overwhelmed with substantially high flow of the gases. In this case, additional sieve beds may be used in the system 10 if desired, which may add weight and volumetric size to the system 10.

Evenly distributing the flow of the gases through the sieve beds 12, 14, may be accomplished by operatively disposing at least one flow distribution device in the housing 52 of the sieve bed 12, 14. In a non-limiting example, the flow distribution device is disposed at an inlet side 60 of the sieve beds 12, 14. The flow distribution device is configured to deflect, divert, and/or displace gases flowing through the sieve bed 12, 14 such that the gases flow evenly through the nitrogen-adsorption material disposed in the sieve bed housing 52. It is to be understood that the physical geometry (e.g., the shape) of the flow distribution device suitably deflects, diverts, and/or displaces the gas flow. Non-limiting examples of suitable flow distribution devices include a flow director, a diffuser, a baffle, and/or the like, and/or combinations thereof.

In a non-limiting example, as shown in FIG. 2, the sieve beds 12, 14 include two flow distribution devices: a diffuser 56 and a baffle 62. It is to be understood however, that the configuration of the sieve beds 12, 14 shown in FIG. 2 is one example. Several configurations are possible such as, e.g., having one flow distribution device disposed in the housing 52 of the sieve beds 12, 14, or possibly more than two distribution devices disposed in the housing 52. In another example, the sieve bed 12, 14 may include a diffuser 56 without a baffle 62, or visa versa. In yet another non-limiting example, one or more flow distribution devices may be incorporated into the system 10 prior to the sieve beds 12, 14. For example, a flow distribution device may be provided in, e.g., a supply conduit, and substantially evenly distribute the feed gas into the sieve beds 12, 14. This may also be accomplished in systems including multiple sieve beds. It is to be understood that the combination and/or configuration of flow distribution devices disposed in the housing 52 of the sieve beds 12, 14 may be selected based on the desired flow rate of the gases flowing through the sieve beds 12, 14.

In yet another embodiment, the sieve beds 12, 14 include at least one flow conduit operatively connected thereto such as, e.g., the supply conduits 16, 18 and the user conduits 28, 28′, 28″. The nitrogen-adsorption material generally naturally diffuses the flow of the gases inside the sieve beds 12, 14. If desired, further diffusion of the gases may be accomplished by one or more of the conduits 16, 18, 28, 28′, 28″, where the conduits 16, 18, 28, 28′, 28″ are configured to have an orifice that is designed and/or shaped to substantially prevent undesired pressure drop during the pressure swing adsorption process, to substantially prevent turbulent flow of at least one of the feed gas or the oxygen-enriched gas, or combinations thereof. In some examples of the present disclosure, the flow of the gases is such that the flow is substantially laminar. In a non-limiting example, the orifice may be designed and/or shaped as a grid structure, a screen, a pleated filter structure, a honeycomb structure, and/or the like.

It is to be understood that maintaining a substantially low internal sieve bed pressure during the PSA process allows for the construction of the sieve beds 12, 14 in the system 10 with significantly thinner and/or lighter polymeric or metallic materials for the sieve bed housing 52. This results in substantially smaller amounts of material of the housing 52 of the sieve beds 12, 14 and/or thicknesses of the housing 52, as well as lighter (in terms of weight) and economically less expensive sieve beds 12, 14, as compared to those of many other systems currently operating with substantially high internal sieve bed pressures (e.g., an internal pressure ranging from about 15 psi to about 45 psi). The materials used in those systems operating at higher internal sieve bed pressures are generally selected so that the sieve beds 12, 14 may be able to withstand the pressure cycle loads and fatigue evident of the cyclic PSA process.

It is further to be understood that operating the sieve beds 12, 14 at a substantially low pressure enables a relatively more consistent and/or finer control of the compression means 24. Additionally, the internal device temperature is dependent on the compressibility of the feed gas, where higher pressures dictate higher temperatures of the compressed gas. Operating the sieve beds 12, 14 at a substantially low pressure enables the internal device temperatures to be reduced, thereby simplifying the system 10 and reducing the need for temperature control mechanisms. Such temperature control mechanisms tend to add cost, weight, and/or complexity to the overall system 10. Yet further, temperature control mechanisms also tend to be noisy.

Yet further, it is to be understood that the systems that are operated at high pressure often include a pressure regulator to reduce the pressure of the oxygen-enriched gas to be delivered to the user. By operating the sieve beds 12, 14 in the system 10 at a substantially low pressure, a relatively accurate, substantially safe and/or comfortable amount of oxygen-enriched gas may be generated and delivered to the user without having to include a pressure regulator in the system 10.

It is to be understood that the term “connect/connected” is broadly defined herein to encompass a variety of divergent connection arrangements and assembly techniques. These arrangements and techniques include, but are not limited to (1) the direct connection between one component and another component with no intervening components therebetween; and (2) the connection of one component and another component with one or more components therebetween, provided that the one component being “connected to” the other component is somehow operatively connected to the other component (notwithstanding the presence of one or more additional components therebetween).

While several embodiments have been described in detail, it will be apparent to those skilled in the art that the disclosed embodiments may be modified and/or other embodiments may be possible. Therefore, the foregoing description is to be considered exemplary rather than limiting.

What is claimed is:

1. A system for generating an oxygen-enriched gas, comprising:
compression means configured to compress a feed gas including at least nitrogen and oxygen; and
at least one sieve bed configured to generate an oxygen-enriched gas from the compressed feed gas, the at least one sieve bed having an internal gas pressure ranging from about 1 psi to about 10 psi, the at least one sieve bed including:
a housing; and
a nitrogen-adsorption material operatively disposed in the housing, wherein the nitrogen-adsorption material is configured to adsorb at least nitrogen from the compressed feed gas during a pressure swing adsorption process, thereby generating the oxygen-enriched gas for a user.

2. The system as defined in claim 1, further comprising at least one flow distribution device operatively disposed in the housing in a manner sufficient to promote substantially evenly distributed flow of at least one of the feed gas or the oxygen-enriched gas through the at least one sieve bed.

3. The system as defined in claim 2 wherein the at least one flow distribution device is selected from a flow director, a diffuser, a baffle, and combinations thereof.

4. The system as defined in claim 1, further comprising at least one flow conduit operatively connected to the at least one sieve bed, wherein the at least one flow conduit includes an orifice having a diameter suitable to substantially prevent undesired pressure drop during the pressure swing adsorption process, turbulent flow of at least one of the feed gas or the oxygen-enriched gas, or combinations thereof.

5. The system as defined in claim 1 wherein the compression means is selected from a compressor designed to achieve a substantially low internal sieve bed pressure and a substantially high flow rate of at least one gas flowing through the at least one sieve bed, wherein the gas flowing through the at least one sieve bed is at least the feed gas and the oxygen-enriched gas.

6. The system as defined in claim 5 wherein the compressor is one of a scroll compressor, a high volume piston compressor, or a rotary vane compressor.

7. The system as defined in claim 5 wherein the substantially high flow rate of the at least one gas ranges from about 10 slpm to about 30 slpm.

8. The system as defined in claim 1 wherein the at least one sieve bed is operated at a pressure ranging from about 2 psi to about 8 psi.

9. The system as defined in claim 1 wherein the at least one sieve bed is operated at a pressure ranging from about 1 psi to about 2 psi.

10. The system as defined in claim 1 wherein the compression means is an air blower.

11. The system as defined in claim 1 wherein the system is portable.

12. The system as defined in claim 1 wherein the system does not include a pressure regulator.

13. A method for generating an oxygen-enriched gas via an oxygen generating system, the oxygen generating system including at least one sieve bed and a compression means configured to compress a feed gas, the at least one sieve bed including a nitrogen-adsorption material operatively disposed therein, the method comprising:
achieving an internal sieve bed gas pressure ranging from about 1 psi to about 10 psi; and
adsorbing, in the at least one sieve bed, at least nitrogen from the compressed feed gas via a pressure swing adsorption process.

14. The method as defined in claim 13 wherein achieving the internal sieve bed gas pressure is accomplished by selecting the compression means from a compressor designed to achieve a substantially low internal sieve bed pressure and a substantially high flow rate of at least one gas flowing through the at least one sieve bed, wherein the gas flowing through the at least one sieve bed is at least one of the feed gas or the oxygen-enriched gas.

15. The method as defined in claim 14 wherein the compressor is selected from a scroll compressor, a high volume piston compressor, and a rotary vane compressor.

16. The method as defined in claim 13 wherein achieving the internal sieve bed pressure ranging from about 1 psi to about 10 psi is further facilitated by substantially evenly distributing the flow of at least one of the feed gas or the oxygen-enriched gas through the at least one sieve bed.

17. The method as defined in claim 16, further comprising operatively disposing at least one flow distribution device in the at least one sieve bed in a manner sufficient to promote the substantially evenly distributed flow.

18. The method as defined in claim 17 wherein the at least one flow distribution device is selected from a flow director, a diffuser, a baffle, and combinations thereof.

19. The method as defined in claim 16 wherein the substantially evenly distributed flow of at least one of the feed gas or the oxygen-enriched gas ranges from about 10 slpm to about 30 slpm.

20. The method as defined in claim 13, further comprising achieving an internal sieve bed gas pressure ranging from about 1 psi to about 2 psi.

21. The method as defined in claim 20 wherein the compression means is an air blower.
